(19) United States
(12) Patent Application Publication
(10) Pub. No.: US 2002/0079387 A1
(43) Pub. Date: Jun. 27, 2002

(54) Spray beam at a printing press roller

(76) Inventor: Birger Hansson, Akarp (SE)

Correspondence Address: Steven S. Payne, 8027 ILIFF Drive, Dunn Loring, VA, 22027, US

(21) Appl. No.: 09/924,507

(22) Filed: Aug. 9, 2001

(30) Foreign Application Priority Data
Feb. 10, 1999 (SE) 9900433-5

(51) Int. Cl. B05B 1/14

(52) U.S. Cl. 239/551

(57) ABSTRACT

A spray beam is arranged at a printing press roller and is provided with a number of spray valve and nozzle assemblies for spraying a fountain solution on the roller. The position of each individual spray valve and nozzle assembly may be adjusted for adjusting the spray distance to the roller.

### TECHNICAL FIELD

The present invention relates to a spray beam to be arranged at a printing press roller, the beam being provided with a number of spray valve and nozzle assemblies for spraying a liquid on the roller.

### BACKGROUND OF THE INVENTION

When spraying a fountain solution on a rotating printing press roller it is of great importance that the liquid is evenly distributed. Normally, the position of the whole spray beam can be adjusted for obtaining an optimal mean spray distance for all the spray valve and nozzle assemblies. Due to the fact, however, that individual spray valve and nozzle assemblies do not provide the same spray pattern, certain spray valve and nozzle assemblies may have to be replaced in order to obtain the desired even spray, and still the result is not necessarily good enough. Also after replacement of defective spray valve and nozzle assemblies, problems with an even spray may occur.

The purpose of the invention is to obviate the above drawbacks and to provide for a fully satisfactory distribution of fountain solution on the printing press roller.

### THE INVENTION

This is according to the invention attained in that the position of each individual spray valve and nozzle assembly may be adjusted for adjusting the spray distance from the nozzle to the roller.

Due to the possibility to individually adjust the position of the spray valve and nozzle assemblies, the spray beam may have a fixed position relative to the roller, and still a fully satisfactory distribution of fountain solution can be obtained. Also after a possible removal of a defect assembly and replacement by and adjustment of a new assembly, said distribution can remain satisfactory. Altogether an improved economy is attained together with an improved spray result.

In practice the desired result may be obtained by means for slidably mounting each spray valve and nozzle assembly to the spray beam and means for slidably transferring the spray valve and nozzle assembly in relation to the spray beam.

### BRIEF DESCRIPTION OF THE DRAWINGS

The invention will be described in further detail below reference being made to the accompanying drawings, in which

FIG. 1 is a schematic perspective view of an arrangement including a spray beam according to invention,

FIG. 2 is an end view of a spray beam according to the invention,

FIG. 3 is a view along the line III-III in FIG. 2, and

FIG. 4 is a view along the line IV-IV in FIG. 2.

### DETAILED DESCRIPTION OF A PREFERRED EMBODIMENT

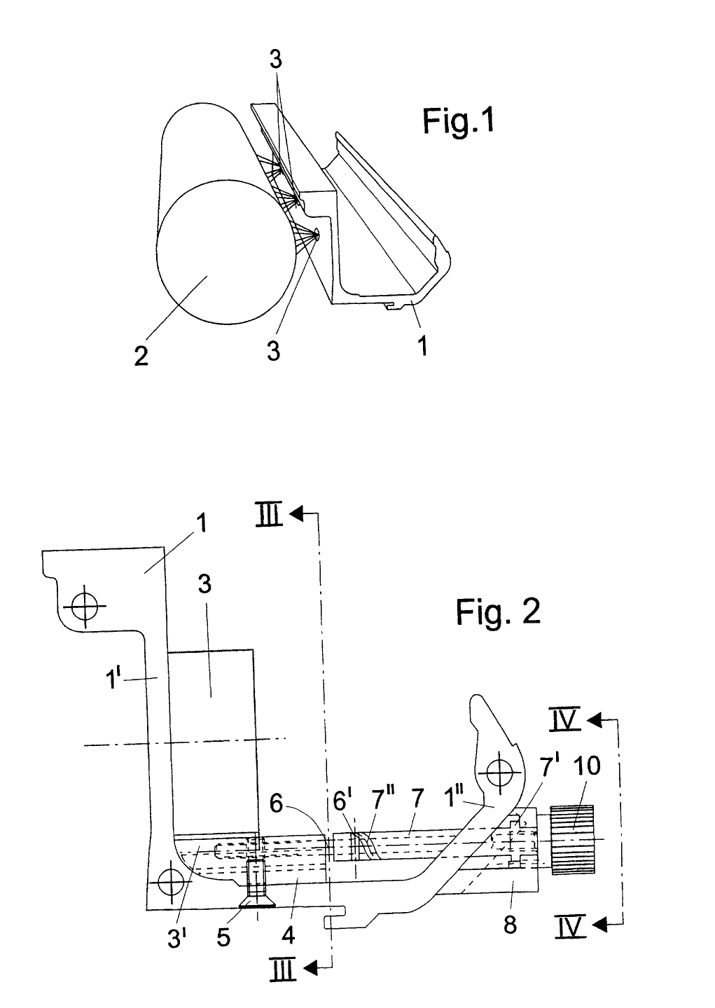

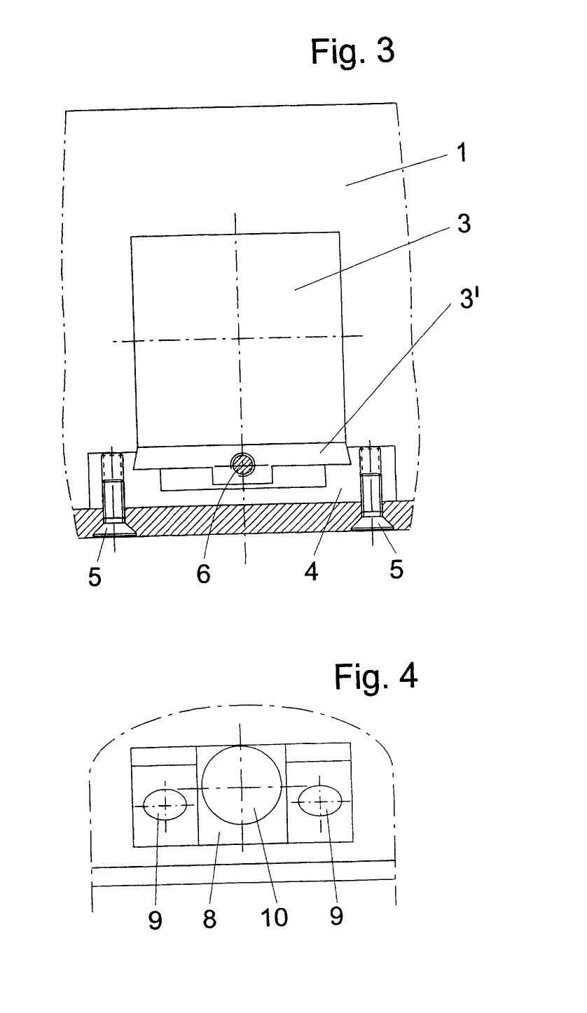

FIG. 1 illustrates—with many details omitted for the sake of clarity—a so called spray beam 1 arranged in the vicinity of a rotating printing press roller 2. The spray beam is provided with a certain number of spray valve and nozzle assemblies 3 (FIG. 2) for the purpose of evenly spray or damp the roller with fountain solution or the like. For attaining this purpose or in other words for positioning the nozzles optimally, each assembly 3 may be individually adjusted in relation to the spray beam 1, for example in the way illustrated in FIGS. 2-4 and described below. The spray valve and nozzle assembly 3 is only depicted as a “black box”, but its design and function are well known in the art; accordingly no specific description thereof is given.

In a first flange 1′ to the left in FIG. 2 the spray beam 1 is provided with a hole for each spray valve and nozzle assembly 3 to extend through. By means of an exemplary mechanism to be described, the spray valve and nozzle assembly 3 can be transferred to the left or to the right in FIG. 2 for attaining an optimal position in relation to the roller 2. However, the invention is not limited to the use of this specific mechanism, which as readily appears to the person skilled in the art may be replaced by any suitable alternative mechanism.

For each spray valve and nozzle assembly 3 the spray beam 1 is provided with an attachment 4 mounted by means of screws 5. The spray valve and nozzle assembly 3 is underneath provided with a sleigh 3′ slidingly cooperating with the attachment by means of a dovetail connection. Threadingly engaged with the sleigh 3 is a rod 6 extending to the right in FIG. 2.

In a second flange 1″ to the right in FIG. 2 the spray beam 1 is provided with a hole for a tube 7 cooperating with the rod 6 in a way to be described. A socket 8 is attached to the second flange 1″ at the hole by means of screws 9. The tube 7 extends through a journalling bore in the socket 8 and has a flange 7′ for contacting the inner surface of the socket 8. This end of the tube 7 has a threaded bore for receiving a threaded end of a control knob 10, by which the tube 7 can be turned in either direction.

At its protruding end the rod 6 is provided with a pin 6′ in engagement with a helical groove 7″ in the tube, so that by turning the tube 7 by means of the knob 10 at the exterior of the spray beam 1 the rod 6 and hereby the sleigh 3′ and the spray valve and nozzle assembly 3 will be transferred to the desired extent in relation to the first flange 1′ of the spray beam 1.

Other practical ways of accomplishing the individual positioning of the spray valve and nozzle assemblies in relation to the spray beam are of course possible. Thus, it may for example be possible to provide an eccenter mechanism or a linear adjustment by means of a slide mechanism with a locking screw or a gear rack mechanism.

Further, the purpose of the invention is to enable an individual adjustment of the distance between the spraying nozzle and the roller. For the case that the nozzle and the spray valve are separate units, the position adjustment according to the invention is for the nozzle.

1. A spray beam (1) to be arranged at a printing press roller (2), the beam being provided with a number of spray valve and nozzle assemblies (3) for spraying a liquid on the roller, characterized in that the position of each individual spray valve and nozzle assembly (3) may be adjusted for adjusting the spray distance from the nozzle to the roller (2).

2. A spray beam according to claim 1, characterized by means (3′, 4) for slidably mounting the spray valve and nozzle assembly (3) to the spray beam (1) and means (6, 7, 10) for slidably transferring the spray valve and nozzle assembly in relation to the spray beam.

3. A spray beam according to claim 2, characterized by a dovetail connection between a sleigh (3′) underneath the spray valve and nozzle assembly (3) and an attachment (4) on the spray beam (1).

4. A spray beam according to claim 2, characterized by a rod (6) attached to the spray valve and nozzle assembly (3) and a tube (7) rotatably journalled in relation to the spray beam (1), the rod having an end pin (6′) cooperating with a helical groove (7″) in the tube.

5. A spray beam according to claim 4, characterized in that the tube (7) is journalled in a socket (8) attached to the spray beam (1) and is provided with a control knob (10).
